(19) United States
(12) Patent Application Publication
(10) Pub. No.: US 2022/0213786 A1
(43) Pub. Date: Jul. 7, 2022

(54) MACHINE LEARNING TECHNICS WITH SYSTEM IN THE LOOP FOR OIL & GAS TELEMETRY SYSTEMS

(71) Applicant: ONESUBSEA IP UK LIMITED, London (GB)

(72) Inventors: Arnaud Jarrot, Clamart (FR); Andriy Gelman, Somerville, MA (US); Arnaud Croux, Brookline, MA (US); Sepand Ossia, Sugar Land, TX (US)

(21) Appl. No.: 17/595,197

(22) PCT Filed: Jul. 14, 2020
(86) PCT No.: PCT/US2020/042010

§ 371 Date: Nov. 11, 2021

Related U.S. Application Data
(60) Provisional application No. 62/847,789, filed on May 14, 2019.

(51) Int. Cl. E21B 47/12

(52) U.S. Cl. CPC E21B 47/12; E21B 2200/22

(57) ABSTRACT

A telemetry system is provided. The telemetry system includes a transmitter configured to convert digital bits representative of oil and gas operations into an analog signal and to transmit the analog signal via a communications channel. The telemetry system further includes a receiver configured to receive the analog signal and to convert the analog signal into output digital bits via an encoder, wherein the receiver comprises one or more receiver components trained via machine learning to process the analog signals for improved communications.

### CROSS-REFERENCE TO RELATED APPLICATION

This application claims priority to and the benefit of U.S. Provisional Application No. 62/847,789, entitled “MACHINE LEARNING TECHNICS WITH SYSTEM IN THE LOOP FOR OIL & GAS TELEMETRY SYSTEMS,” filed May 14, 2019, which is hereby incorporated by reference in its entirety for all purposes.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In subsea operations, hydrocarbon fluids (e.g., oil and natural gas) may be obtained from a subterranean geologic formation, referred to as a reservoir, by drilling a well that penetrates the subterranean geologic formation. Telemetry systems may be used in the oil & gas industry to communicate information in real-time between the subsurface to the surface while drilling (e.g. mud pulse telemetry, electromagnetic telemetry) or between subsea vehicle to surface vehicles (e.g. underwater communication). For example, drilling data may transmit from the subsurface to the surface, as well as data from subsea vehicles (e.g., inspection data). It would be beneficial to improve communications systems and methods of communication.

### SUMMARY

In an embodiment, telemetry system is provided. The telemetry system includes a transmitter configured to convert digital bits representative of oil and gas operations into an analog signal and to transmit the analog signal via a communications channel. The telemetry system further includes a receiver configured to receive the analog signal and to convert the analog signal into output digital bits via an encoder, wherein the receiver comprises one or more receiver components trained via machine learning to process the analog signals for improved communications.

In an embodiment, a method is provided. The method includes converting digital bits representative of underwater machine operations into an analog signal via a transmitter. The method further includes transmitting the analog signal via a communications channel, and receiving, via a receiver, the analog signal. The method additionally includes converting the analog signal into output digital bits via an encoder, wherein the receiver comprises one or more receiver components trained via machine learning to process the analog signals for improved communications.

In an embodiment, non-transitory computer readable media storing instructions is provided. The instructions when executed cause a processor to convert digital bits representative of underwater machine operations into an analog signal via a transmitter, and to transmit the analog signal via a communications channel. The instructions further cause the processor to receive, via a receiver, the analog signal and to convert the analog signal into output digital bits via an encoder, wherein the receiver comprises one or more receiver components trained via machine learning to process the analog signals for improved communications.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is a schematic illustration of a subsea system that includes a communications system suitable for telemetry, according to an embodiment of the present disclosure;

FIG. 2 is a schematic illustration of a communications system that includes a transmitter and a receiver, according to an embodiment of the present disclosure;

FIG. 3 is a block diagram of an embodiment of a packet data structure and packet filter processing, according to an embodiment of the present disclosure;

FIG. 4 is a block diagram illustrating a machine learning process for data packet detection, according to an embodiment of the present disclosure;

FIG. 5 depicts a receiver operating characteristics (ROC) graph, according to an embodiment of the present disclosure;

FIG. 6 depicts side-by-side graphs for tuning or certain communication parameters, according to an embodiment of the present disclosure;

FIG. 7 is a block diagram illustrating a communications system having a tuning agent, according to an embodiment of the present disclosure;

FIG. 8 is a perspective view of a receiver array, according to an embodiment of the present disclosure;

FIG. 9 is a schematic diagram illustrating a modem string, according to an embodiment of the present disclosure;

FIG. 10 is a graph of energy of the signal received at the surface during underwater machine operations, according to an embodiment of the present disclosure;

FIG. 11 is a schematic diagram illustrating a communications system with automatic spectrum sensing and classification, according to an embodiment of the present disclosure;

FIG. 12 is a graph illustrating an embodiment of a pulse shaping filter, according to an embodiment of the present disclosure;

FIG. 13. illustrates a block diagram of an embodiment of a communications system suitable for pulse shape modelling, according to an embodiment of the present disclosure;

FIG. 14 is a block diagram depicting an embodiment of a system suitable for generating training data, according to an embodiment of the present disclosure;

FIG. 15 is a block diagram illustrating an embodiment of an end-to-end learning communications system with system-in-the-loop capabilities, according to an embodiment of the present disclosure; and

FIG. 16 is a block diagram illustrating a process suitable for using machine learning with communication systems, including oil and gas telemetry systems, according to an embodiment of the present disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

One or more specific embodiments of the present disclosure will be described below. These described embodiments are only exemplary of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments, the articles “a,” “an,” “the,” “said,” and the like, are intended to mean that there are one or more of the elements. The terms “comprising,” “including,” “having,” and the like are intended to be inclusive and mean that there may be additional elements other than the listed elements. The use of “top,” “bottom,” “above,” “below,” and variations of these terms is made for convenience, but does not require any particular orientation of the components relative to some fixed reference, such as the direction of gravity. The term “communications” encompasses one-way transmissions, two-way interchange of information, or a combination thereof.

The disclosure herein generally involves a system and methodology for adaptive communications via certain machine learning techniques, such as neural networks. The adaptive communications systems described herein may include, for example, telemetry systems. Different telemetry systems may used in oil and gas applications, such as Logging While Drilling (LWD) telemetry in different forms (mud pulse, electromagnetic, acoustic, and the like), which provides for a technology suitable for lower-cost Measuring While Drilling (MWD)/LWD operations. Another communications system, such as an untethered underwater communications, may be a promising solution to enable the inspection of subsea assets by underwater untethered robots without the risk of a tether becoming caught or entangled. These communications systems may each include a propagation channel that is not precisely known, and a signal generation that may become distorted by digital to analog and analog to digital chains present in the communication systems. In addition, telemetry may become extremely sensitive to environmental noise. For example, depending on the operational conditions (e.g., salinity, distance, water temperature, thermoclines, and the like), the signal power measured at surface can be several orders of magnitude smaller than the noise, thus preventing reliable demodulation of the telemetry signal. Because of more limited power available on the transmitter side, increasing the energy of the signal may not always be possible, and may only provide marginal improvements on the energy level at surface. Conversely, preventing the noise in the environment (e.g., underwater environment) is a difficult task due to the large variety of potential noise sources.

According to certain embodiments, the communications systems described herein include machine learning systems suitable for adapting all or part of the telecommunication building blocks (e.g., receiver building blocks, transmitter building blocks) to a specific communications platform of interest. For example, neural networks may be trained (e.g., via supervised training, semi-supervised training, unsupervised training, or a combination thereof) to create one or more machine learning agents that may provide tuning “packages” to one or more telecommunication building blocks that encompass specific hardware (hardware-in-the-loop) as well as specific software (software-in-the-loop) of interest. The learning agents may compensate for adverse effects of physical communications layers without using an explicit model of signal propagation. The learning agents may additionally learn a more efficient tradeoff between cancelling of noise and equalization of the receive signal. Further, internal parameters (e.g., communication systems parameters) may be adjusted based changes in a propagation channel.

In certain embodiments, a reinforcement learning (RL) for hyperparameters tuning agent is provided. The tuning agent may use RL techniques as further described below to tune parameters used by receivers and transmitters. For example, receiver parameters that may be tuned via RL may include equalizer size (e.g., number of feedforward taps, number of feedback taps, or a combination thereof), tracking loop parameters, threshold (e.g., correlation coefficient for synchronization), filtering parameters (e.g., frequency of notch filter, bandpass filter parameters, stopband filter parameters, and so on), or a combination thereof. Transmitter parameters that may be tuned via RL may include a central frequency, a constellation map, a data rate/bandwidth, error correction code mode and related parameters, transmitter pulse shape, power, or a combination thereof. It is to be noted that the receiver tuning may be independent and thus not need communication or cooperation with the transmitter. Likewise, the transmitter tuning, except for pulse shape, may be independent and not need communication or cooperation with the receiver.

In certain embodiments, machine learning systems may be trained to classify and segment a spectrum into specific regions where noise may be strong and thus lead to interference. The classification and/or segmenting techniques may analyze different channels and provide regions of interest bounded by a time interval (e.g., between a start time Tstart and a stop time Tstop), a frequency interval (e.g. between a start frequency fstart and a stop frequency fstop), and or a physical region (e.g., a square or other shape of a volume of ocean at a certain depth). Information detected by the classification and/or segmenting techniques may then be used to avoid time-frequency (and/or physical) regions where the strongest noise is present or use this information as prior knowledge for subsequent noise cancelation algorithms.

In certain embodiments, complex hardware and/or channels may be modeled. For example, Generative Adversarial Networks (GANs) may be used to generate data sets which may include modeling the communications channel (e.g., subsea environment) as well as modeling a complete communications chain. Indeed, a generator and discriminator pair may be used to simulate more realistic datasets, including propagation channel(s), which may then be used by other embodiments described herein for training, for example. Accordingly, an end-to-end learning with hardware in the loop may be provided, which may use machine learning to tune telecommunication building blocks such as demodulation, filters, packet synchronization, equalization, decoding, error correcting codes, and the like.

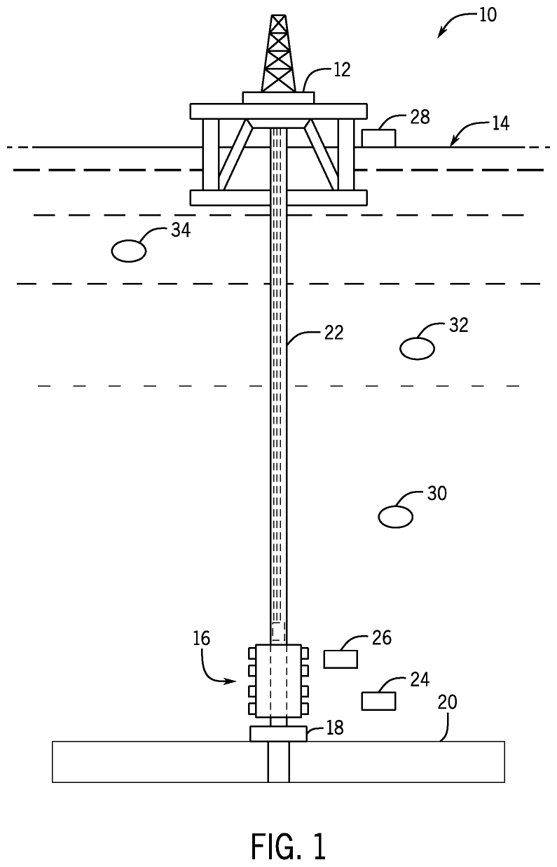

Turning now to FIG. 1, the figure is an embodiment of a subsea system 10. As shown, the subsea system 10 includes an offshore vessel or platform 12 at a sea surface 14. A stack assembly 16 (e.g., a blowout preventer (BOP) stack and/or a lower marine riser package (LMRP)) is mounted to a subsea production tree 18 at a sea floor 20. A riser 22 (e.g., marine drilling riser) extends from the platform 12 to the stack assembly 16. An untethered underwater communications system is 24 is also shown, which may include a subsea transmitter 24 which may be communicatively coupled to oil and gas equipment, such as equipment 16, 18, sensing equipment 26 (e.g., sensors, LWD equipment, MWD equipment, and the like), to provide data to the surface 14. Accordingly, a receiver 28 may be used, suitable for receiving data transmitted via the transmitter 24.

Also shown are communication nodes 30, 32, 34. In certain embodiments, the nodes 30, 32, 34 may provide for retransmission of data (e.g., data “hopping”), thus enabling for longer transmission distances and improved transmission energy. The communication nodes 30, 32, and/or 34 may be included, for example, in untethered remote underwater vehicles. However, it is to be understood that the communication nodes 30, 32, and/or 34 may be additionally or alternatively included in other electronics not part of a remote underwater vehicle. By providing for communicative systems 24, 28, 30, 32, 34, a mesh network may be created, suitable for communications (e.g., one-way communication, two-way communication) between members of the mesh network and the surface 14. By using the techniques described herein, the mesh network may be an adaptive communications system, which may learn and adapt to environmental conditions, to specific hardware, to specific software, or to a combination thereof, thus providing for end-to-end learning, with hardware and/or software in the loop.

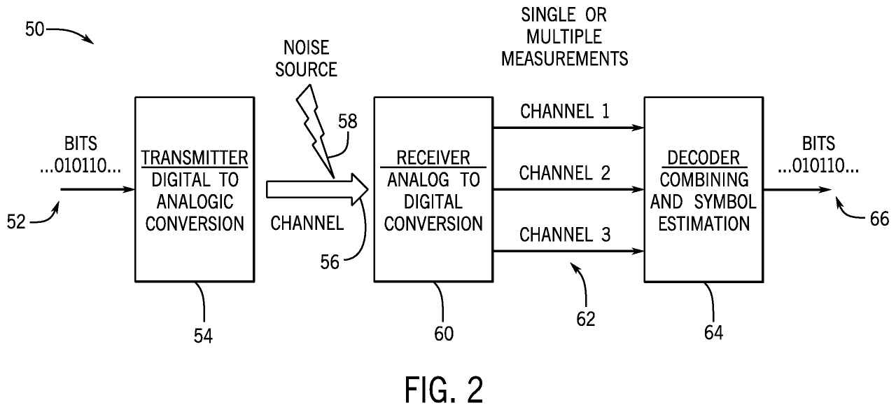

It may be beneficial to describe a transmission of data, as illustrated in FIG. 2. More specifically, the figure depicts an embodiment of a communications system (e.g., telemetry system) 50, which may be used in oil and gas applications. In use, input data 52 (i.e., digital data) may undergo conversion to analog data via a transmitter 54. For example, techniques such as phase-shift keying (PSK), frequency-shift keying (FSK), quadrature amplitude modulation (QAM), orthogonal frequency-division multiplexing (OFDM), amplitude shift keying (ASK), and other digital modulation techniques may be used to transform the digital data 52 into an analog encoding. Once encoded, the signal may be modulated, converted into an electrical signal, amplified, and transferred to a transducer. The transmitter may transmit analog signals via a communications channel 56. However, a noise source 58 may inject unwanted noise and obfuscate the transmission. Techniques PSK, FSK, QAM, OFDM, ASK, and the like, may prove to be optimal assuming perfect electronics, simple propagation channels and little noise.

The transducer in a receiver 62 may sense the transmitted analog signal, demodulate the analog signal, and convert the analog signal into a digital signal. The digital signal may include, for example, one or more measurements (e.g., channels) 62. A decoder 64 may then convert the digital signal into output data 66 (e.g., digital data bits). Systems and algorithms used for creating encoded bits usually do not consider the hardware or the presence of specific noise signature(s) in the environment. Consequently, the overall performance of the communication system is likely degraded compared to the expected performance (or theoretical performance if additive white Gaussian noise (AWGN) is assumed). The systems and algorithms may be optimized for a specific environment in terms of the electronics (i.e. hardware used), a propagation model and a noise. However, this approach may be relatively expensive and time-consuming as the conception of good propagation models by a human may be a tedious task.

As an alternative, the techniques described herein may leverage machine learning to train certain agents based on certain targeted platforms of interest (hardware and software in the loop) in order to “tune” or otherwise specialize the telecommunication algorithms to specific hardware and/or software platform(s). This machine learning approach may not require specialized expertise as the more optimal parameters are directly learned from the data.

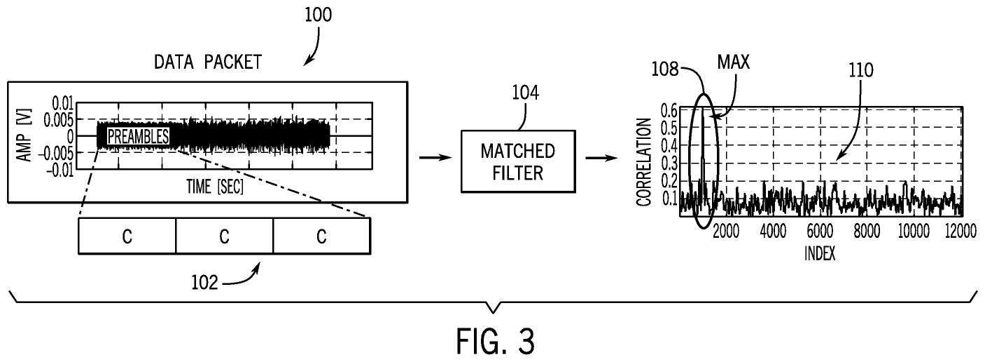

The machine learning approach described herein may have several applications. For example, and turning now to FIG. 3, a machine learning approach may be used for packet detection. In FIG. 3, the figure illustrates an embodiment of a data packet structure 100 which may have been transmitted into a communications channel, such as the channel 56 shown in FIG. 2. The data packet 100 is shown as beginning with a predefined preamble section 102. In some communication systems, a matched filter 104 may be used to detect the preamble 102, for example as a component in OFDM communications. In the depicted example, the figure illustrates an instant in time where a peak 108 is detected in a signal 110 as corresponding to the preamble 102. The instant in time for the peak 108 may then be used later to synchronize the signal received by the receiver. The matched filter 104 approach may work well when signals are being transmitted through a simple propagation channel with AWGN noise. However, a more complex channel (e.g., subsea environment) may quickly deteriorate the performance of preamble detection systems that use the matched filter 104.

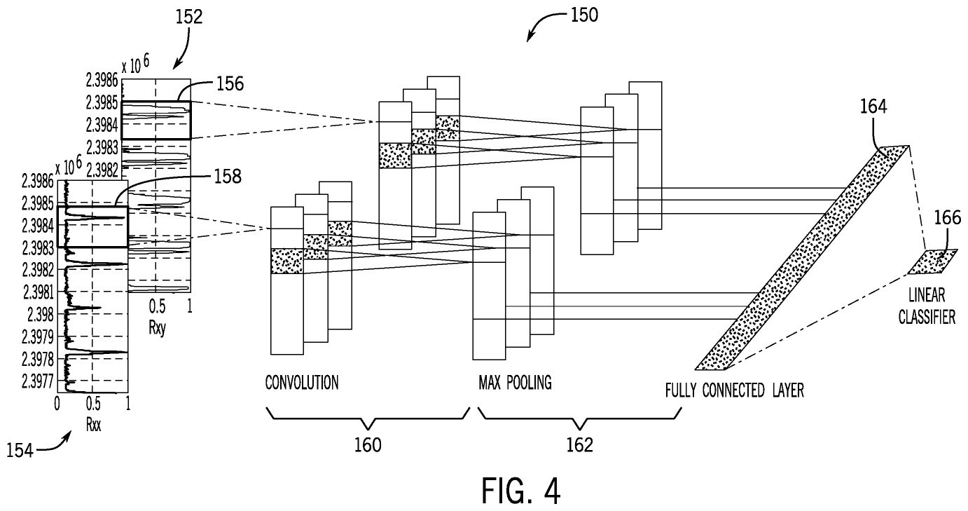

Advantageously, an embodiment of a machine learning process for data packet detection is shown in FIG. 4. In the depicted embodiment, a cross-correlation (Rxy) process 152 may be combined with an autocorrelation or self-correlation (Rxx) process 154. For example, the cross-correlation process 152 may leverage prior knowledge of the preamble 102, while the self-correlation process 154 may leverage repeating preamble 102 patterns. Rxy and Rxx inputs may then be provided to convolutional layers 160. The convolutional layers 160 may apply learned filters to input in order to create feature maps that summarize the presence of those features in the input.

Max pooling layers 162 may then be used, for example, to calculate a maximum value for each patch in a feature map. A fully connected layer 164 may then be used to transition from the feature maps to an output prediction. Accordingly, a linear classifier neural network 166, for example, may be created, suitable for making a classification decision (e.g., preamble found, preamble not found) based on input data, such as the data packet 100 shown in FIG. 3. It is to be understood that other machine learning techniques may be used to detect the preamble 102 in addition to or alternative to the linear classifier neural network 166, such as state vector machines (SVMs), decision tree learning, association rule learning, deep learning, inductive logic programming, genetic algorithms, data mining, and so on. Likewise, other types of neural networks, such as radial basis function neural networks, Kohonen self-organizing neural networks, recurrent neural networks, modular neural networks, and so on, may be trained and used to detect the preamble 102 for subsequent processing of the data packet 100.

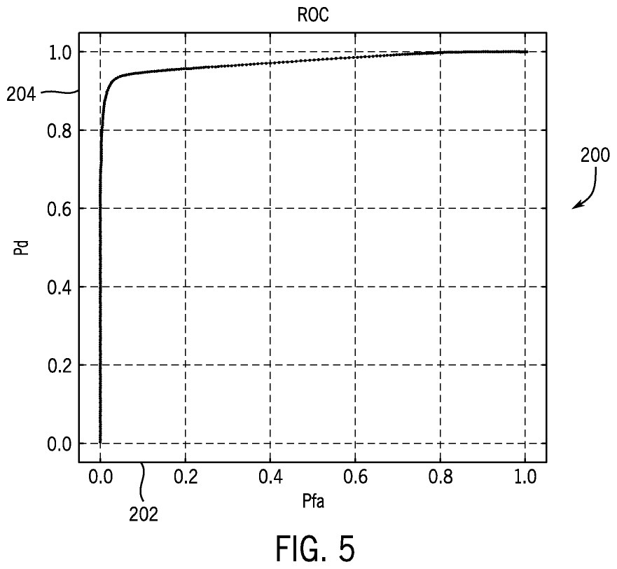

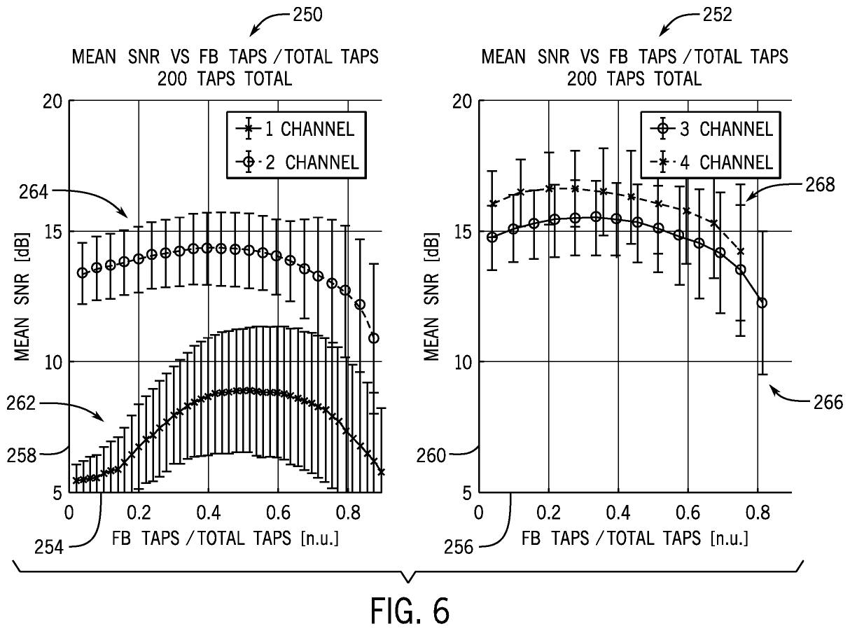

FIG. 5 shows an embodiment of a receiver operating characteristics (ROC) graph 200 having a curve that shows the results of training of the linear classifier neural network 166. In the depicted embodiment, the ROC graph 200 includes a probability of false alarm axis 202 as a function of a probability of detection axis 204, using, for example, test datasets. As illustrated, the linear classifier neural network 166 achieves excellent detection performance, which may be better than manual policies designed by a human. A variety of communications blocks may be improved with the techniques described herein. For example, and turning now to FIG. 6, machine learning may be used to improve tuning of certain systems, such as by tuning hyperparameters. More specifically, the figure illustrates side-by-side graphs 250 and 252 for tuning certain receiver equalizer “lengths”, such as by tuning number of feedforward and/or feedback taps of the equalizer.

In the depicted embodiment, graphs 250, 252 include axis 254 and 256 respectively, of a ratio of feedback (FB) taps to total taps. The graphs 250, 252 additionally include axis 258 and 260, respectively, of a mean signal-to-noise (SNR) in decibels. Graph 250 shows 1 and 2 channel embodiments, while graph 252 shows 3 and 4 channel embodiments. Reinforcement learning (RL) may be used for hyperparameter tuning to determine a more optimal number of FB taps, for example, for a given mean SNR. Telecommunication receivers may depend on many parameters that may need to be constantly adjusted to match a specific environment. Performances of the receiver have been found to be highly dependent on the allocation of the feedforward and feedback taps as illustrated. The optimal parameters may depend on the specific communication channel being used as well as the geometry of a receiver array. Consequently, these parameters are dynamic and may need to be adjusted manually during each deployment scenario. This manual optimization is typically done by experienced engineering personnel, who typically receive extensive training. In many cases the manual optimization may not be done, leading to the performance of the communications system not being fully utilized.

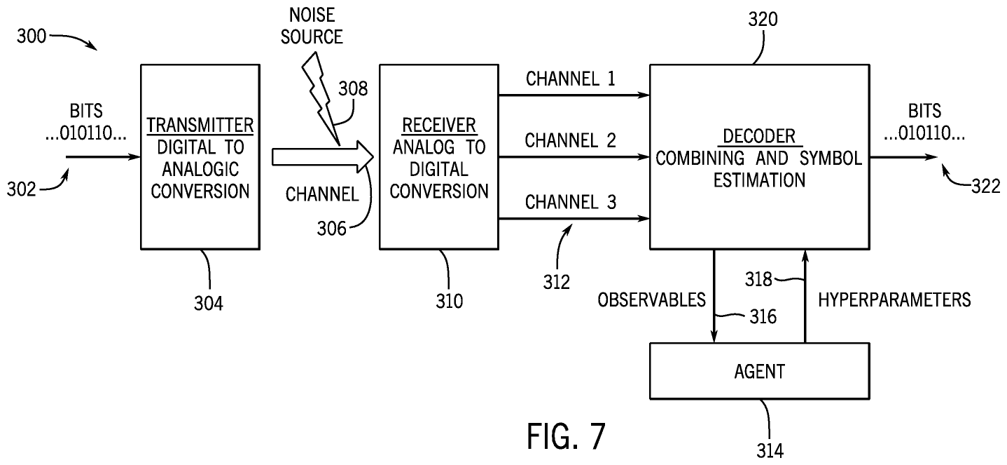

As an alternative to manual adjustment of the parameters, the techniques described herein include applying a Reinforcement Learning technique for training an agent to automate the optimization of the parameters in a given receiver configuration. An agent architecture is shown in FIG. 7. More specifically, the figure is a block diagram illustrating an embodiment of an agent 314 that may have been trained via RL. As mentioned earlier, digital data 302 enters a transmitter 304 for conversion to analog data. The transmitter 304 then uses a channel 306 to transmit an analog signal. Noise source(s) 308 may inject noise, thus obfuscating the transmitted signal. A receiver 310 may then convert the received signal into digital signals, which may be split into one or more channels or measurements 312. A decoder 320 may then convert the digital signals into output data 322 (e.g., digital data bits).

The agent 314 may reading information from “observables” 316. The observables 316 may include intermediate data in the receiver 310 pipeline. This intermediate data may include the time traces available after each processing block inside the receiver 314, such as time traces of packet detection, time traces of a constellation phase shift, soft symbols before and after error correcting codes, and so on. Hyperparameters 318 may be any parameters of interest which may be adjusted to improve the performance of the receiver or to otherwise “tune” the receiver. For example, hyperparameters 318 may include parameters of a syncword detection to adjust to the background noise level, an allocation of feedforward and feedback filters to compensate the channel 306, and/or parameters of tracking loops to compensate for the variation in propagation speed (e.g., doppler).

A neural network used in the agent 314 may be trained offline using a large dataset of test signals where the transmitted symbols are known. The training dataset is representative of the real operational conditions encountered in field deployment and a reward function may be defined such that the correct recovery of the decoded bits is rewarded while incorrect recovery is penalized. The agent 314 is then trained until it learns how to leverage the observables to maximize the reward. In use, the agent 314 may then adaptively tune the receiver 310 and/or decoder 320, thus improving signal receipt and conversion into the digital bits 322.

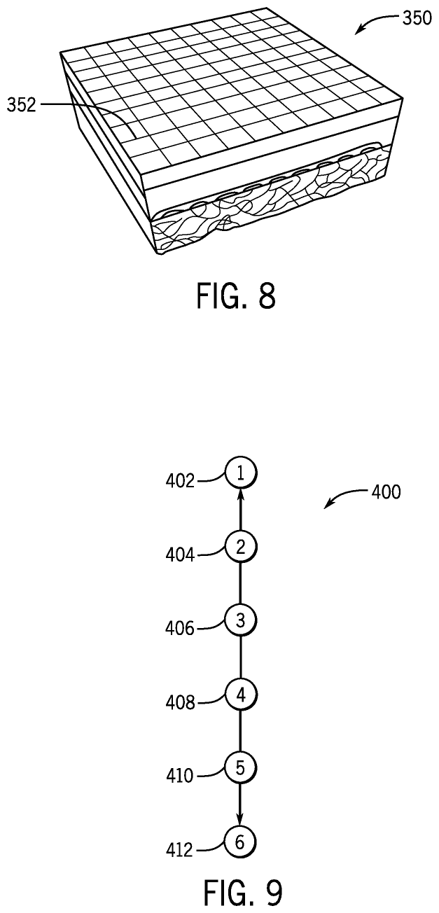

In cases of multiple channel receivers, it may be appropriate to pick a limited number of channels to perform the decoding. Limiting the number of channels reduces the complexity of the decoder and it may avoid adding noise in the decoder. Selecting the relevant channels to feed the decoder is a non-trivial task. It depends heavily on the spatio-temporal aspects of the channel. For example, when the channel 306 is saltwater, salinity, temperature, detritus, flows, and so on, may affect signals over time. The techniques described herein include using reinforcement learning to adaptively pick the channels to use. A typical example is the use of one or multiple channel receiver arrays as shown in FIG. 8.

More specifically, FIG. 8 depicts a receiver array 350 having 10×10 piezo elements 352 (e.g., multichannel receiver array having 100 channels). Out of the all channels, it might be more optimal and realistic to only use a few, 10 channels out of 100 for example. The selection of the channels 312 may depends on factors that may be very mission specific, such as environmental factors. The environmental factors might include the physical locations of the transmitter, the type of noise sources, the coherence of the noise, the spatial coherence of the channels, and so on. These factors may result in an optimization problem that may be very hard to solve for each deployment of the communication system. The techniques describe herein include using RL to learn in situ what are the best channels to use during communications.

Additionally, some parameters of the transmitters must often be adjusted to achieve a more robust and optimal telemetry. Those parameters comprise but are not limited to the central frequency of the telemetry signal, the bandwidth, the data rate, the pulse shaping, the error-correcting codes, the packet maximal size, the preamble characteristics. Other parameters may include parameters used in the actual signal modulation, e.g., parameters used for PSK, FSK, QAM, OFDM, ASK, and the like. Under the assumption of a bi-directional communication link, it may be possible to exchange side information between the transmitter 304 and the receiver 310/decoder 320. Hence, the receiver/decoder may inform the transmitter 304 with information useful in improving communications. At least a couple of communication system architectures may be used to optimize the transmitter parameters.

In one architecture, RL is executed in the receiver 304 using a set of indicators to assess the reward such as signal quality, telemetry statistics, and the like. Decisions to change the transmitter 304 parameters are sent from the transmitter 304 to the receiver 310 using the bi-directional link. In a second architecture, RL is executed in the transmitter 304 using information that is sent from the receiver 310 to the transmitter 304 using the bi-directional link. Both architectures may also be used in combination.

Turning now to FIG. 9, the figure illustrates a network of modems 400. In certain oil and gas operations, wireless communication from the rig to the downhole tools may be achieved using some network of modems that relay the information from one end to the other end. An untethered system was described previously in FIG. 1. Another example of this topology may be implemented for the acoustic telemetry through pipes. When using pipes as a channel 306, human intervention may be required to update communication parameters and the spectrum of optimization is usually limited. The techniques described herein may leverage Reinforcement Learning (RL) to better optimize the communication path through one or more modems, such as through modems 402-412, and the transmitter parameters to optimize the telemetry system in the context of the network of modem 400s. A proposed solution is to implement RL in the top node 402 or in a processing unit connected to the top node 402. The path and the associated parameters to communicate from the top node 402 to the targeted node (e.g., nodes 404-412) may then be optimized by the RL algorithm, processing observations such as data throughput, latency, stability. Accordingly, an more optimized communications system of modems 402-412 may be provided, a system that uses pipes as a communications channel.

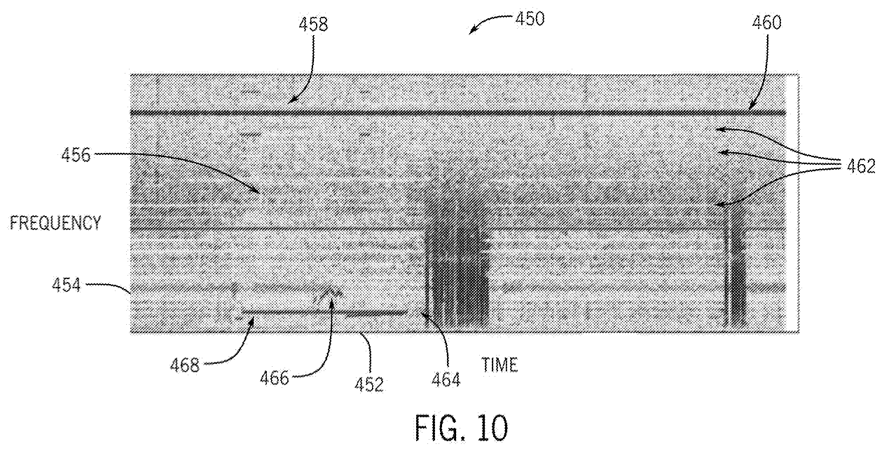

FIG. 10 is a graph of energy of the signal received at the surface 14. More specifically, a graph 450 is depicted having a time axis 452 and a frequency axis 454. Telecommunications equipment may be more highly sensitive to perturbations caused by external noise on a bandwidth of interest (e.g., bandwidth used to communicate). In the depicted embodiment, a variety of noise is shown. For example, impulsive noise 456, unidentified noise 458, powerline noise 460, pump noise 462, broadband noise 464, noise 466 correlated with rig (block position/weight on bit (WOB)/hookload), and noise 468 correlated with drilling revolutions per minute (RPM) are shown.

As shown in FIG. 10, bandwidth may exhibit strong interferences pattern caused by external noise sources. External noise sources can be generated by large range of sources, including equipment present at the surface (e.g. electrical motors) or other tools in the neighborhood of the well. One important aspect for improving the reliability of the telecommunication signal consists in finding the most suitable bandwidth where external noise sources will have a minimum impact the signal to be transmitted. This task is usually performed by human experts analyzing the spectrogram and finding the most suitable bandwidth used for transmission.

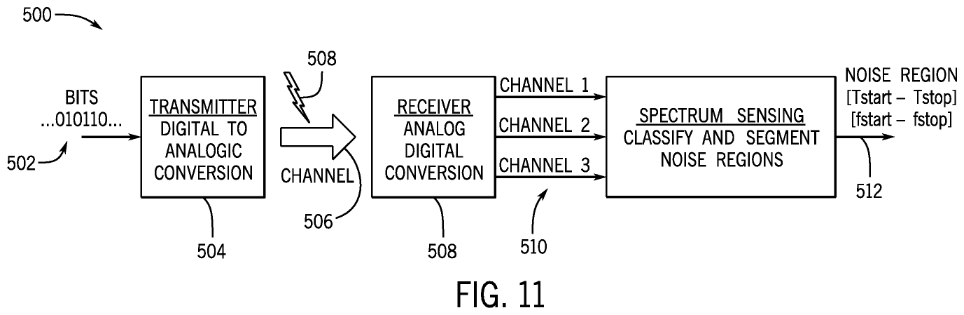

Alternately, a machine learning technique may be used for the communication systems described herein where an automated system has been trained to classify and to segment the spectrogram into specific regions where noise is strong and could interfere with the region of interest. Turning now to FIG. 11, the figure is a block diagram illustrating an embodiment of a communication system 500 with automatic spectrum sensing and classification. In the illustrated embodiment, digital bits 502 are used as input into a transmitter 504. The transmitter 504 may then convert the digital bits 502 into analog signal(s) for transmission via a channel 506. Noise sources 508 may inject noise into the channel 506, which may obfuscate the transmitted signal(s). A receiver 508 may then convert the analog signal(s) into digital signals, which may be split into one or more channels or measurements 510. Spectrum sensing may then classify and/or segment noise regions.

For example, machine learning be used to identify noises, such as the noises 456-468, as well as regions (e.g., frequencies, times, geographic locations) where the noises 456-458 occur. Indeed, the illustrated spectrum sensing analyzes different channels 510 and provides regions of interest bounded by a time interval [Tstart-Tstop] and/or a frequency interval [fstart-fstop] 512. Information 512 detected by the spectrum sensing may be consequently used to avoid time-frequency regions where the strongest noise is present or use this information as prior knowledge for subsequent noise cancelation. This technique may be used with all other techniques described herein, including combinations with the agent 314.

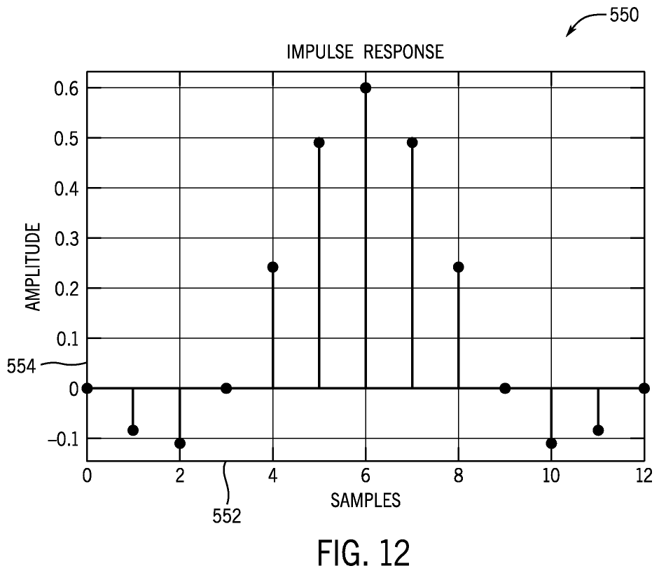

FIG. 12 is a graph illustrating an embodiment of a pulse shaping filter 550. More specifically, the filter 550 is a root-raised cosine filter 550. Non-linearity in the analog to digital chain may be found in oil and a gas telecommunication systems. These non-linearities may be caused by variations in the frequency response of the transducer (e.g. underwater acoustics transducers), by non-linearity caused by the technology of the signal amplifier, by the low resolution of the Digital-to-Analog-Converter (transmitter), and/or by Analog-To-Digital converter (receiver) as well as frequency selectivity of the frequency channel.

Telecommunication receivers may traditionally use “pulse shaping filters” to reduce the bandwidth occupancy of the telecommunication signal. A choice for pulse shaping is to use the root-raised cosine filter 550 shown in FIG. 12. An advantage of the root-raised cosine filter 550 is characterized by a zero inter-symbol interference pattern in the center of adjacent symbols. Still, the optimality of the filter 550 require that the whole telecommunication chain to be linear which, for real telecommunication systems, may never be verified. Furthermore, in the context of Faster Than Nyquist telecommunication, the optimal pulse-shaping filter is generally unknown and must then be determined empirically.

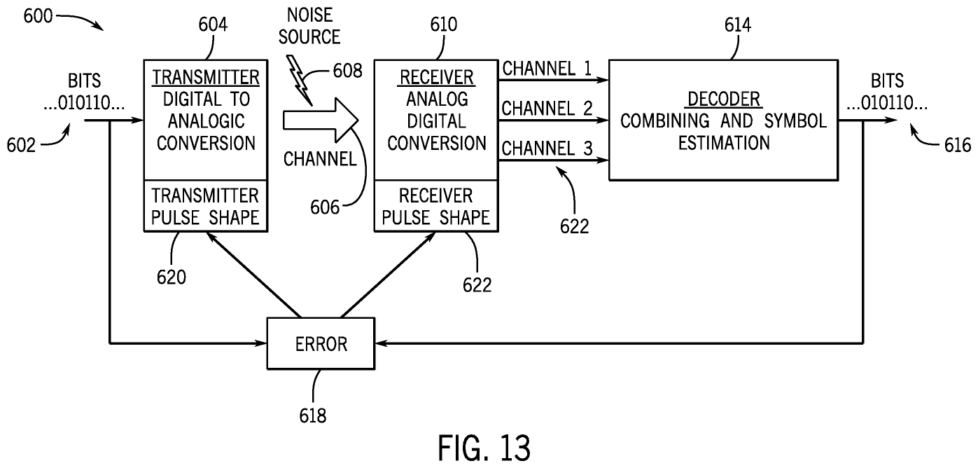

As an alternative or additional to pulse shaping, machine learning techniques described herein may learn a more optimal filter by performing a system-in-a-loop learning, using production hardware and software in the transmitter, the receiver, the decoder, and so on, as part of the learning chain. An embodiment of a communication systems architecture that may use system-in-a-loop learning is shown in FIG. 13. More specifically, the figure illustrates a block diagram of an embodiment of a communications system 600 suitable for pulse shape modelling via neural network(s).

In the depicted embodiment, digital bits 602 may be used an input by a transmitter 604 for conversion into analog signal(s). The signal(s) may then be transmitted via communications channel 606. A noise source 608 may inject noise into the channel 606, thus obfuscating the transmitted signal(s). A receiver 610 may receive the analog signal(s) and convert the analog signal(s) into digital signals. The digital signals may be split into one or more channels or measurements 612. A decoder 614 may then decode the digital signals and provide digital bits 616 as output.

The input bits 602 and the output bits 616 may be compared to derive an error 618. The error 618 may then be used to train a neural network. For example, a transmitter and receiver pulse shape 620, 622 may be modelled by a neural network with unknown weights. The neural network may be initially trained in a supervised manner by minimizing an error function (e.g., error 618) between the transmitted bits 602 and the received bits 616. The system can either be trained using the real hardware and/or software operating in a real propagation channel 606, or leveraged on a simulated channel to accelerate the initial training. It is to be noted that the adaptive pulse shaping described with respect to the communications system 600 may be included in addition to or alternative to any other communications system described herein. By providing for in situ machine learning for adaptive pulse shaping, the techniques described herein may result in more optimal field communications in noisy channels, including subsea channels.

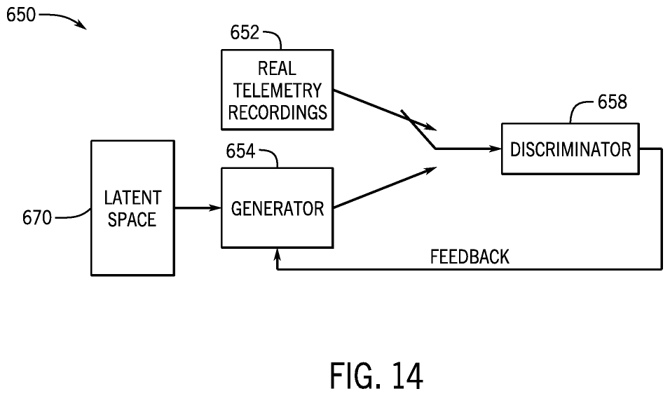

FIG. 14 is a block diagram depicting an embodiment of a telemetry system 650 suitable for generating training data. Because of the cost associated to the access of a realistic propagation channel, (e.g. underwater communication channel), the training of machine learning systems using a database large enough might be challenging task. As an alternative to physical modelling where the cost for achieving the modelization of the complete communication chain might be prohibitive, the depicted embodiment illustrates the use of Generative Adversarial Networks (GANs) to learn a realistic model of the communication system, including hardware non-linearities and channel impairments.

In the GAN embodiment of the telemetry system 650 illustrated in FIG. 14, a real telemetry dataset 652 and a dataset generated via a generator 654 are sent to a discriminator 658. The discriminator 658 may randomly alternate between the real telemetry dataset 652 and the dataset generated by the generator 654. The discriminator 658 may be trained to recognize a real dataset from a generated dataset while the generator 654 is trained to minimizing the success rate of the discriminator 658. Also shown is a latent space 670 that the generator's datasets may come from. Using techniques such as GANs, the techniques described herein may train one or more neural network on a propagation channel of interest to include channels such as those used in underwater communications, mud pulse telemetry, electromagnetic telemetry, acoustic through pipe telemetry, and/or cable telemetries (e.g., wireline, slickline)), and then use the trained neural network to simulate realistic datasets which will be used for the training of the machine learning systems described previously. By applying GAN techniques to the creation of training neural networks, a faster and more efficient training for a variety of communication systems may be provided.

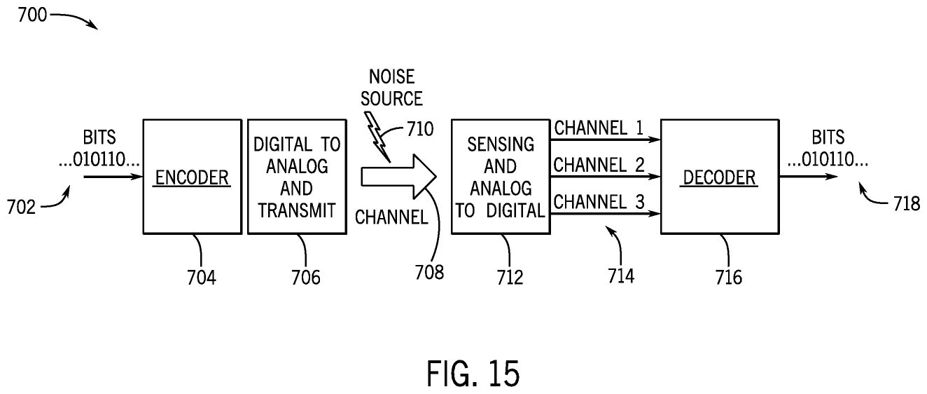

FIG. 15 is a block diagram illustrating an embodiment of an end-to-end learning communications system 700 with system-in-the-loop capabilities. Classical telecommunication systems are traditionally based on well-defined building blocks. such as demodulation, matched filter, packet synchronization, equalization, decoding, and error correcting codes. While it can be proven that such systems can provide the best achievable performances on simple communication channels by achieving the channel capacity, no proof of optimality exist in case of hardware non-linearity and selectivity in the propagation channel. The study and design of telecommunication architectures that are well suited to the target hardware and channel of interest (e.g. mud pulse telemetry, electromagnetic telemetry, acoustic through pipe telemetry, and/or cable telemetries (e.g., wireline, slickline)) may be a time consuming and expensive task.

As an alternative to or in addition to traditional design, the embodiments disclosed herein, such as the communications system 700, may use autoencoders techniques (e.g., autoencoder neural networks) for achieving an end-to-end leaning of the telecommunication channel. In the depicted embodiment, digital bits 720 may be used as input into an encoder 704, the bits may be converted into analog signals to be transmitted (block 706) via a channel 708. The channel 708 may have noise injected by noise sources 710, obfuscating the transmitted signals. A sensing and analog to digital block 712 may then receive the analog signals and transform the received signals into digital signals. The digital signals may be split into one or more channels or measurements 714, which may then be decoded via decoder 716 into digital bits 718.

The architecture embodiment of FIG. 15 is built around a traditional Encoder-Decoder architecture, except that the hardware of interest is included in between these building blocks. Accordingly, the system 500 may be trained on a real deployment scenario or using a simplified propagation channel. That is, as the communications system 500 operates, data may be captured in one or more building blocks (e.g., receiver, transmitter, pulse generator, and the like) and used by an autoencoder neural network to adjust or otherwise tune the communications system 500 based on previous training. Accordingly, a dynamically adjustable communications system 500 may be provided, that uses system-in-the-loop techniques for end-to-end adjustments.

Adaptive coupling of underwater navigation and mission-specific acoustic telemetry may also be used. For example, an outer-layer of automation executed above the underwater telemetry layer would under permissible circumstances trigger adaptive path and task planning to maximize the discovery or duration of an autonomous underwater vehicle (AUV) occupation of a region favorable to up-linking robustly inspection/surveying frames that would otherwise be unachievable along the normal path of the AUV. One such example, could be periodic transmission of inspection video/lidar images during a close-up inspection of a production equipment (pumps operating in gas-liquid flow regime) that generates significant acoustic noise, by virtue of managing reasonably short trips between the equipment and a favorable transmission zone. The tradeoff between completion of the close-up inspection and in-process uplinking could be learnt by reinforcement learning.

Cloud reinforcement learning using streaming data from multiple field locations may also be provided. In traditional reinforcement learning, the underlying model is typically learned offline using example field or synthetic data. During field operations, the learned model is shared with multiple agents (i.e. field locations) and is used for inference of parameters as discussed in other sections of this memo. However, in a setup with multiple agents, each agent is unaware of the data at other field locations, and the inference model is generally fixed for the duration of the job. To utilize real-time data from multiple field locations, the techniques described herein may use data that is streamed in real-time to a centralized server (i.e. the cloud). In the server, new samples are used to improve the inference model for edge cases and in terms of the overall reliability. The updated inference model is then periodically shared with all the field locations.

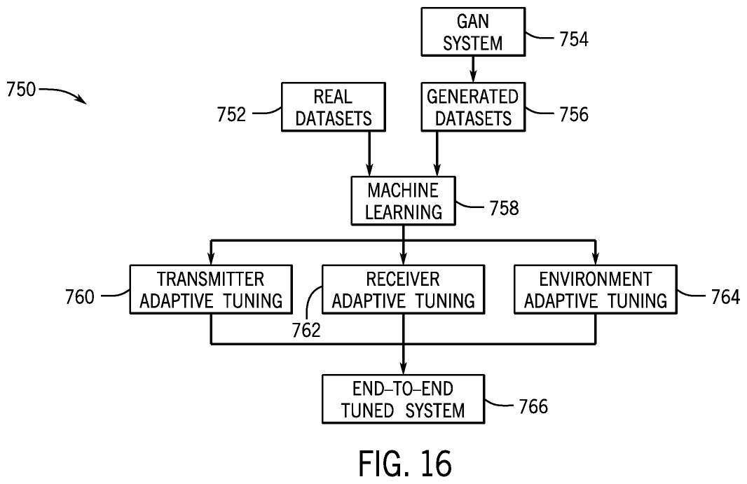

FIG. 16 is a block diagram illustrating a process 750 suitable for using machine learning with communication systems, including oil and gas telemetry systems. The process 750 may be implemented as computer code or instructions executable via one or more processors (e.g., microprocessors) and stored in memory. In the depicted embodiment real dataset(s) 752 may be combined with a GAN system 754 and generated dataset(s) provided via the GAN system 754. The datasets 752 and/or 756 may then be used in machine learning (block 758) as described in the figures above. The machine learning may then result in adaptive systems, such as transmitter adaptive systems 760, receiver adaptive systems 762, and/or communications systems 764 that adapt to environmental conditions (e.g., underwater communications, mud pulse telemetry, electromagnetic telemetry, acoustic through pipe telemetry, and/or cable telemetries (e.g., wireline, slickline)). The communications systems (e.g., subsea acoustic communications systems) may additionally be used for oil and gas (e.g., subsea production field) but also for offshore wind fields. Training of components may be supervised, unsupervised, semi-supervised, or a combination thereof.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. Furthermore, any of the features shown and/or described with respect to FIGS. 1-16 may be combined in any suitable manner.

What is claimed is:

1. A telemetry system, comprising:
a transmitter configured to convert digital bits representative of oil and gas operations into an analog signal and to transmit the analog signal via a communications channel; and
a receiver configured to receive the analog signal and to convert the analog signal into output digital bits wherein the receiver comprises one or more receiver components trained via machine learning to process the analog signals for improved communications.

2. The system of claim 1, wherein the one or more receiver components comprises a neural network configured to detect a data packet preamble transmitted via the communications channel.

3. The system of claim 1, wherein the one or more receiver components comprises a neural network agent configured to use receiver and/or decoder observables and to generate hyperparameters for tuning of the receiver and/or a decoder.

4. The system of claim 3, wherein the hyperparameters comprise parameters of an allocation of feedforward and feedback filters to compensate the communications channel, parameters of tracking loops to compensate for the variation in propagation speed, or a combination thereof.

5. The system of claim 1, wherein the one or more receiver components comprise a neural network configured to provide a receiver pulse shape to filter the analog signal.

6. The system of claim 5, comprising a transmitter component trained via machine learning to provide a transmitter pulse shape for transmitting the analog signal, wherein the transmitter pulse shape and the receiver pulse shape cooperate to improve the receipt of the analog signal.

7. The system of claim 1, comprising one or more transmitter components trained via machine learning to process transmitter information, wherein the one or more transmitter components, the one or more receiver components, or the combination thereof, are trained via a dataset created by a Generative Adversarial Network (GAN).

8. The system of claim 1, comprising one or more transmitter components trained via machine learning to process transmitter information, wherein the one or more transmitter components, the one or more receiver components, or the combination thereof, are trained via an autoencoder neural network that accounts for system-in-the-loop data transmissions.

9. The system of claim 1, wherein the one or more receiver components are trained to provide for spectrum sensing that classifies noise and provide indications noise-free regions in the communications channel.

10. A method for telemetry, comprising:
converting digital bits representative of underwater machine operations into an analog signal via a transmitter;
transmitting the analog signal via a communications channel;
receiving, via a receiver, the analog signal; and
converting the analog signal into output digital bits, wherein the receiver comprises one or more receiver components trained via machine learning to process the analog signals for improved communications.

11. The method of claim 10, wherein the underwater machine operations comprise oil and gas operations, wind power operations, or a combination thereof, and wherein the one or more receiver components comprises a neural network configured to detect a data packet preamble transmitted via the communications channel.

12. The method of claim 11, wherein the one or more receiver components comprises a neural network agent configured to use receiver and/or decoder observables and to generate hyperparameters for tuning of the receiver and/or a decoder.

13. The method of claim 11, wherein the transmitter comprises comprising one or more transmitter components trained via machine learning to process transmitter information before transmitting the analog signal.

14. The method of claim 11, wherein the one or more transmitter components, the one or more receiver components, or a combination thereof, are trained via supervised training, via semi-supervised training, via unsupervised training, or a combination thereof.

15. The method of claim 11, comprising generating a training dataset via machine learning for training of the one or more receiver components.

16. A non-transitory computer readable media storing instructions that when executed by a processor cause the processor to:
convert digital bits representative of underwater machine operations into an analog signal via a transmitter;
transmit the analog signal via a communications channel;
receive, via a receiver, the analog signal; and
convert the analog signal into output digital bits via an encoder, wherein the receiver comprises one or more receiver components trained via machine learning to process the analog signals for improved communications.

17. The non-transitory computer readable medium of claim 16, wherein the underwater machine operations comprise oil and gas operations, wind power operations, or a combination thereof, and wherein the one or more receiver components comprises a neural network configured to detect a data packet preamble transmitted via the communications channel.

18. The non-transitory computer readable medium of claim 16, wherein the one or more receiver components comprise computer instructions for a neural network configured to detect a data packet preamble transmitted via the communications channel, to use receiver and/or decoder observables for the generation of hyperparameters for tuning of the receiver and/or a decoder, or a combination thereof.

19. The non-transitory computer readable medium of claim 16, wherein the one or more receiver components, one or more transmitter components, or a combination thereof, are trained via supervised training, via semi-supervised training, via unsupervised training, or a combination thereof.

20. The non-transitory computer readable medium of claim 19, wherein unsupervised training comprises executing a autoencoder neural network, a Generative Adversarial Network (GAN), or a combination thereof.
